(19) United States
(12) Patent Application Publication
(10) Pub. No.: US 2008/0115772 A1
(43) Pub. Date: May 22, 2008

(54) Fluid encapsulant for protecting electronics

(75) Inventor: Peter P. Kuperus, Cass City, MI (US)

Correspondence Address: REISING, ETHINGTON, BARNES, KISSELLE, P.C., P O BOX 4390, TROY, MI, 48099-4390, US

(73) Assignee: TI Group Automotive Systems, L.L.C.

(21) Appl. No.: 11/602,940

(22) Filed: Nov. 21, 2006

(51) Int. Cl. F02M 37/10

(52) U.S. Cl. 123/513; 174/17.06

(57) ABSTRACT

An electronics module configured for use within a vehicle fuel tank. The electronics module includes a fluid encapsulant, and electronics immersed in the fluid encapsulant. Preferably, the electronics module includes a sealed housing for carrying the fluid encapsulant and electronics therein, and the fluid encapsulant includes a base fluid and additives to the base fluid to neutralize aggressive compounds in any fuel that may enter the sealed housing.

### FIELD OF THE INVENTION

This invention relates generally to automotive fuel systems and, more particularly, to protecting electronics from fuel.

### BACKGROUND OF THE INVENTION

A vehicle fuel tank often includes a fuel pump assembly in the tank for delivering fuel from the tank to an engine. The fuel pump assembly may be in communication with an electronic control module used for controlling an electric motor of the fuel pump, fuel valves, and a fuel level sensor.

Unfortunately, however, some electronic control modules generate undesirable electromagnetically-radiated emissions, which are amplified by a long run of wiring between an externally-mounted electronic control module and its distantly controlled, internally-carried, electrical devices. Therefore, it is preferable to locate the electronic control module at a location close to the controlled electrical devices. But electronic control modules cannot be located within fuel tanks because sensitive electronics of the electronic control module cannot be protected from certain corrosive compounds in fuel. Such corrosive compounds are aggressive and can degrade the electronics.

Prior solutions to the problem of fuel degrading electronics include using glass-to-metal hermetic seals between components, parylene conformal coatings over glass epoxy, mechanical seals such as polymeric O-rings between components, or solid epoxies covering the electronics. Also, electronics “potting” is a process of covering an electronic assembly with a thermosetting compound for resistance to shock and vibration, and for exclusion of moisture and corrosive agents.

But glass-to-hermetic seals tend to be too expensive for certain high volume applications, and mechanical seals can be relatively ineffective. For example, O-ring seals are not always 100% reliable due to manufacturing and assembly variations, and can degrade over time from constant exposure to aggressive fuel compounds. Also, a solid epoxy tends to expand and contract with changes in temperature, thereby leading to microfissures in the epoxy that collectively define micropaths to the electronics through which the corrosive fuel compounds can migrate. Moreover, none of the solutions above address penetration of corrosive compounds through the walls of the housing components. The result is that electronic control modules are located outside fuel tanks.

### SUMMARY OF THE INVENTION

An electronics module is configured for use within a vehicle fuel tank. The electronics module includes a fluid encapsulant, and electronics immersed in the fluid encapsulant. Preferably, the electronics module includes a sealed housing for carrying the fluid encapsulant and electronics therein, and the fluid encapsulant includes a base fluid and additives to the base fluid to neutralize aggressive compounds in any fuel that may enter the sealed housing. The fluid encapsulant within the sealed housing tends to retard the migration of fuel into the housing by imposing a counterbalancing fluid force on the fuel.

At least some of the objects, features and advantages that may be achieved by at least certain embodiments of the invention include providing an electronic control module that is readily adapted for use in a fuel tank; enables use of standard electronic components; protects electronic components located within a fuel tank so that such components are operable over a long period of time even when completely submerged in fuel; enables use of relatively inexpensive housing and sealing components; resists migration of fuel therein; reduces permeation of fuel through a housing; dilutes corrosive compounds in fuel; neutralizes corrosive compounds in fuel; and is of relatively simple design and economical manufacture and assembly, rugged, durable, reliable and in service has a long useful life.

Of course, other objects, features and advantages will be apparent in view of this disclosure to those skilled in the art. Various other electronic control modules embodying the invention may achieve more or less than the noted objects, features or advantages.

### BRIEF DESCRIPTION OF THE DRAWINGS

These and other objects, features and advantages of the present invention will be apparent from the following detailed description of the preferred embodiment and best mode, appended claims, and accompanying drawings in which:

FIG. 1 is a perspective view of a fuel system including a fuel tank having a presently preferred fuel pump assembly;

FIG. 2 is cross-sectional view of the fuel tank of FIG. 1 including the fuel pump assembly having a presently preferred electronic control module; and

FIG. 3 is a cross-sectional view of a portion of the electronic control module of FIG. 2.

### DETAILED DESCRIPTION OF THE PREFERRED EMBODIMENTS

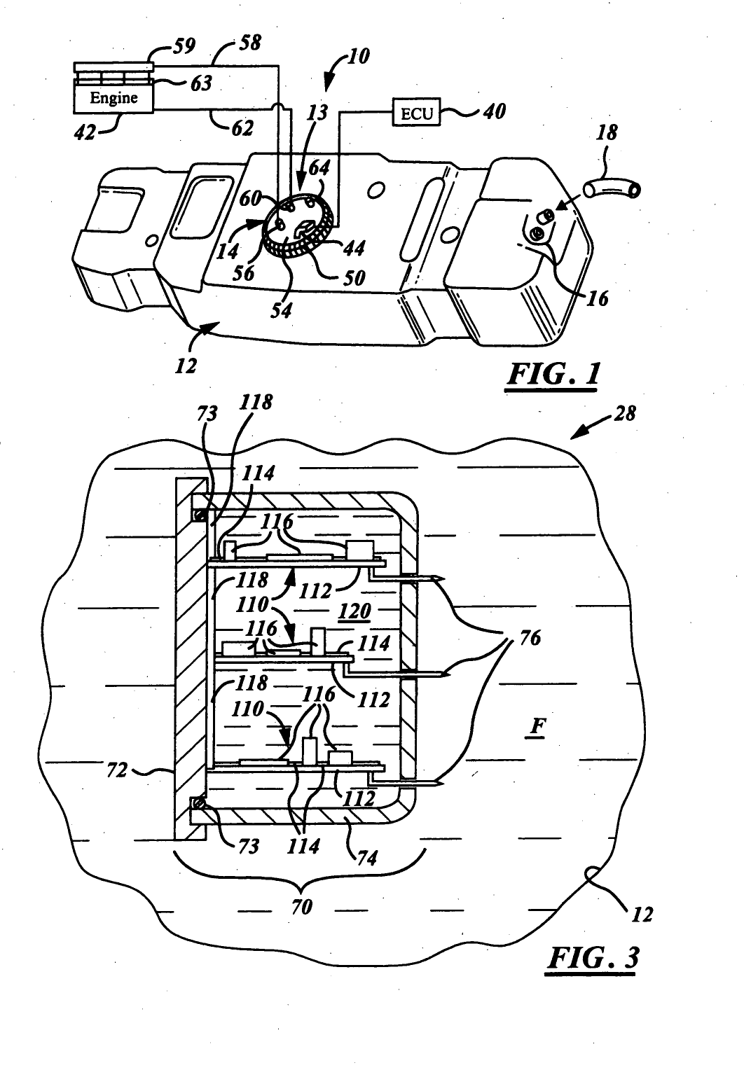

Referring in more detail to the drawings, FIG. 1 illustrates a fuel system 10 including a fuel tank 12 for holding fuel, and a fuel pump assembly 13 for drawing fuel from the fuel tank 12 and pressurizing it for delivery to an engine 42. The fuel system 10 may be any suitable type of system such as a return-type or returnless system or a hybrid of these two systems. The fuel system 10 may be of substantially any suitable type such as that disclosed in U.S. Pat. No. 6,302,144, the disclosure of which is incorporated herein by reference in its entirety.

The fuel tank 12 has a first opening 14 through which a plurality of fuel system components are inserted into the fuel tank 12, and a second opening 16 constructed to communicate with a fill pipe 18 through which fuel is introduced into the fuel tank 12. Fuel discharged from the fuel pump assembly 13 is delivered through a fuel line 58 to a fuel rail 59 of the engine 42, and vapors from the fuel tank 12 can be likewise delivered to an engine intake manifold 63 through a suitable vapor conduit 62 during a vapor canister purge cycle. An engine control unit (ECU) 40 can be communicated with the fuel pump assembly 13 such as for controlling fuel delivery from the tank 12 to the engine 42.

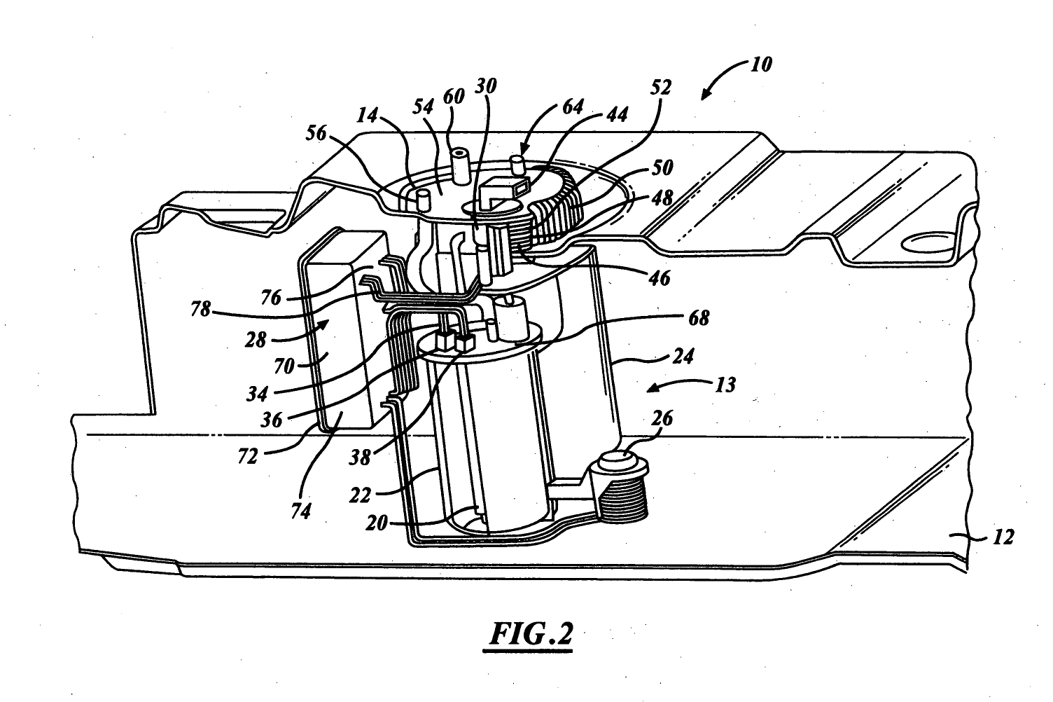

As shown in FIG. 2, a plurality of fuel system components are preferably disposed within the fuel tank 12 to facilitate the integration of the fuel tank 12 and fuel system 10 into a vehicle. At least some of these components disposed within the tank 12 may be submerged in fuel or otherwise exposed to fuel, and may include the fuel pump assembly 13, which may include a fuel pump 20, fuel pump reservoir 22, fuel vapor canister 24, electronic fuel level sensor 26, electronic control module 28, one or more vapor or rollover type valves 30, 32 communicating with the vapor canister 24, and a plurality of sensors including a temperature sensor 34, a hydrocarbon vapor sensor 36, a pressure sensor 38, or any other suitable types of sensors.

The fuel tank 10 preferably has an upstanding annular rim 46 surrounding the first opening 14 with external threads 48 to receive a screw-on cap 50 with a sealing member 52 disposed between the tank 10 and cap 50. The cap 50 preferably has a cover 54 which spans the first opening 14 and which may be integrally or separately formed from the cap 50. The cover 54 preferably has a limited number of openings therethrough to communicate the components within the tank 10 with the exterior of the tank 10. For example, an electrical connector 44 extends through an opening in the cover 54 to interconnect the electrical wires of the tank control module 28 with the corresponding wires connected to the ECU 40. Also, the cover 54 may have a fuel outlet opening 56 for communication with the fuel line 58, a vapor outlet 60 for communicating the fuel vapor canister 24 with the vapor conduit 62, and an opening 64 through which “cleaned” air from the vapor canister 24 is discharged.

The fuel pump 20 is preferably driven by an electric motor and may be carried by a housing 68, which may be carried in any suitable fashion by the cover 54. The fuel pump 20 may be operated at a constant speed, and hence have a constant output fuel flow rate or may be a variable speed type pump to vary the fuel flow rate from the fuel pump 20 as required for various vehicle operating conditions determined by the ECU 40 and the control module 28.

Referring to FIGS. 2 and 3, the electronic control module 28 may be any suitable control device for any suitable purpose within a fuel system, such as a stand alone motor controller, or a fuel pump assembly controller, or a comprehensive fuel system controller. In any case, the electronics control module 28 preferably includes a housing 70 having a base 72 and a cover 74 that are preferably mechanically sealed to one another such as by snap-fit connection with an elastomeric seal 73 (FIG. 3) therebetween, or by welding, ultrasonic welding, or any other type of suitable sealed connection. The base 72 and cover 74 are preferably composed of a fuel-resistant material. The material can be a low cost polymer such as acetyl, polypthalamide (Amodel), or polypropylene. The base 72 and cover 74 can also be composed of more expensive materials such as stainless steel or engineering polymers such as polyphenylene sulfide (PPS), or any other appropriate material exhibiting low fuel permeation characteristics.

As used herein, the phrase polymeric material generally means relatively high-molecular-weight materials of either synthetic or natural origin and may include thermosets, thermoplastics, and elastomers. For use in fuel systems, the polymeric material preferably exhibits suitable resistance to hydrocarbon fuels such as gasoline, gasohol, alcohol, and diesel. The term elastomeric generally means a material, which at room temperature, can be stretched under low stress to about twice its original length or more and, upon release of the stress, will return with force to its approximate original length. Elastomeric also encompasses any of various elastic substances resembling rubber, such as a fluorocarbon like Viton®, a nitrile such as acrylonitrile-butadiene, or the like. In general, the materials used for the components may be selected based on their dimensional stability and resistance to swelling and degradation in warm and cold hydrocarbon fuel environments.

The housing 70 of the module 28 may be mounted in any suitable manner to an interior wall, bottom, or top of the fuel tank 12, carried by or fixed to one of the other components of the fuel system 10 such as various retainers, the fuel pump housing 68, the fuel vapor canister 24, or any other suitable structural members. Preferably, the housing 70 is mounted proximate the top interior of the fuel tank 12, such as to an inside surface of the cover 54 for example.

One or more electrical connector pins 76 may extend through the housing 70, preferably with a suitable seal (not shown) surrounding each pin 76 to reduce the liklihood of fuel entering the housing 70. It is also contemplated that the housing 70 could be injection molded around the pins 76 such that a tight seal is provided around the pins 76 and wherein the pins 76 extend in a tortuous path through the housing 70. It is further contemplated that the pins 76 could be press fit through passages in the housing 70. The various pins 76 may be constructed to communicate information to or from a sensor, fuel system component, the ECU 40, or other components. For example, electrical wires 78 connect the control module 28 to the fuel pump 20 to control the operation of the fuel pump 20, and to the plurality of sensors 34, 36, 38 to receive input therefrom. Other electrical wires and/or pins may be adapted for other uses such as a power supply and ground(s), multiplex bus wires to transmit signals to and from the ECU 40 and electronic control module 28 and if desired, to various other vehicle computer controllers.

Referring to FIG. 3, the electronic control module 28 may be partially or entirely immersed within liquid and/or gaseous fuel F contained within the fuel tank 12, or may otherwise be exposed to sloshing or splashing of liquid fuel and hydrocarbon fuel vapors. The fuel F may be gasoline, diesel fuel, or the like, and may contain corrosive hydrocarbons or other aggressive compounds. Within the housing 70, the electronic control module 28 includes one or more electronic circuits 110 generally including a circuit board or substrate 112, one or more circuit interconnects 114, several circuit components 116, one or more bus bars or wires 118, and an encapsulant 120 composed of a fluid. The substrate 112 may be a flat rigid component or a flexible component that may provide the circuit 110 with structural integrity.

Preferably, the substrate 112 is planar and rectangular or square shaped, although any suitable shape could be used. The substrate 112 is preferably carried by one or both of the base 72 and cover 74 of the housing 70 in any suitable manner, and the pins 76 extend preferably from the substrate 112 through the housing 70. The pins 76 could be soldered or otherwise attached to the substrate 112, or could otherwise be connected to other portions of the circuit 110 such as directly connected to one or more of the circuit components 116. Although not shown in the Figures, the substrate 112 could also include integrally formed mounting features for mounting to an interior surface of the base 72, or any other suitable mounting surface. Such features could include a mounting flange, mounting brackets, screw holes, or any other mounting features known in the art.

The circuit interconnects 114 can be conductive components or portions that attach to the substrate 112 and selectively provide the various circuit components 116 with electrical connectivity. There are numerous types of interconnects known in the art that could be used with the electronic circuit of the present invention. For instance, interconnects 114 could simply be a series of conductive traces, preferably copper, that are directly formed and connected to the substrate 112. In that specific case, the interconnects 114 would not be flat layers, as appears in FIG. 3 but instead would be series of elongated conductive channels well known in the art. The interconnects 114 could also be flat layers, either flexible or rigid, having conductive traces located on its surface, such that the entire layer is fixed to the substrate 112. Alternatively, circuit interconnects 114 could include a series of electrically conductive receptacles for receiving electronic components 116. Such receptacles could receive the components in a snap-fit fashion and have any suitable form of electrical contacts and conductors for selectively coupling the components together.

The circuit components 116 are circuit elements that are coupled to one another via the circuit interconnects 114 and/or may communicate with one another via the wires 118, for example. These components 116 can be either digital or analog, and can include numerous types of components known in the art, such as amplifiers, analog-to-digital converters, microcontrollers or microprocessors, transistors, capacitors, and any other suitable components. Each component 116 preferably has contacts (not shown), such as terminals or traces, extending from a surface thereof such that each component 116 contacts appropriate terminals or portions of corresponding interconnections 114. For example, in the case of an interconnection 114 having conductive traces, the various circuit components 116 would likely have traces or contacts on their lower surfaces that could be soldered to the corresponding traces of the interconnection. In another example, the circuit components 116 could have connection tabs extending from their lower surfaces that were shaped to be received by complimentary openings in the interconnections 114, substrate 112, or corresponding sockets, thereby both mechanically and electrically coupling the parts together. Again, numerous suitable embodiments exist for mechanically and electrically coupling circuit components 116 to interconnections 114.

The wires 118 and pins 76 may be used to transfer power, data signals, or both among the electronic circuits 110 and/or between some other electronic device that could be located outside of or within the fuel tank 12. The wires 118 are preferably connected to the circuit interconnects 114, however, they could alternatively be directly connected to the individual circuit components 116. In either case, the wires 118 are connected to the circuits 110 by any appropriate means, such as soldering, mechanical retention, or the like, and may be composed of a conductive metal, such as copper, or a wave guide material, such as that used in fiber optic applications.

The encapsulant 120 preferably substantially fills the interior of the housing 70. Although it is preferred that the encapsulant 120 substantially fills the housing 70, it is contemplated that less than the entire interior of the housing 70 could be occupied by the encapsulant 120. In any case, it is preferred that enough of the encapsulant 120 is present within the housing 70 to encompass all portions of the circuits 110, such that no part of the circuits 110 is directly exposed to any fuel that may penetrate into the housing 70.

The encapsulant 120 can be any suitable fluid such as a gas and/or a liquid to resist penetration of fuel into the housing 70 and to protect the electronic circuits 110 therein. The encapsulant 120 can be composed of a protective Newtonian liquid based on organic or inorganic fluids, such as transformer oil, silicone fluid, and/or a fluoroinert substance such as FLUORINERT brand electronic liquids available from 3M Corporation. The encapsulant 120 could be composed of a liquid having a greater density than the fuel F. The encapsulant could be composed of a non-Newtonian or pseudoplastic fluid, such as any suitable organic or inorganic gel or grease. As used herein, gel and grease are generally considered a liquid because by weight and volume many gels and greases are substantially liquid in composition and thus exhibit densities similar to liquids, even though such gels may have some solid-like qualities. In any case, any suitable substance(s) could be used that is capable of being contained within the housing 70 and in contact with the substrate 112, interconnects 114, and circuit components 116 such that the substance substantially remains in a fluid or at least flowable or flexible state to provide a protective fluid bath or flexible or flowable coating.

The encapsulant 120 could also include a base fluid and one or more additives to the base fluid to neutralize aggressive compounds in any fuel that may penetrate the housing 70 so that such compounds are rendered incapable of severely damaging the various components. Any suitable additives can be used, for example, corrosion inhibitors can be used, such as hexamine, phenylenediamine, dimethylethanolamine, sodium nitrite, cinnamaldehyde, aldehydes and amines (imines), chromates, nitrites, phosphates, hydrazine, ascorbic acid, zinc oxides, and others.

The encapsulant 120 provides a particularly good repellent to fuel that might otherwise penetrate into the housing 70 and damage the electronics therein. Because the encapsulant.120 is a fluid, and particularly because it is a liquid, the encapsulant 120 will counteract the tendency of liquid fuel from migrating into the interior of the housing 70. In other words, permeation and/or migration of the fuel F from outside of the housing 70 and permeation and/or migration of encapsulant 120 from inside the housing 70 will come close to equilibrium and zero flow. Accordingly, the encapsulant 120 enables use of a relatively low cost housing. Moreover, and unlike a solid encapsulant, the encapsulant 120 is a fluid which does not have micropaths through which the fuel F may migrate and attack the electronics. Rather, any fuel that may enter the housing 70 will become suspended in the encapsulant liquid and, thus, the fuel will become diluted within the fluid encapsulant 120.

Therefore, use of the fluid-encapsulant-filled housing 70 enables the electronics control module 28 to be located inside of the fuel tank 12. Thus, the length of wire or cable can be shortened between the electronic control module 28 and devices external of the fuel tank 12 such as the ECU 40. Shortening of such cable lengths enables reductions in electromagnetic interferences such that the electromagnetic compatibility of the fuel system 10 is increased.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

What is claimed is:

1. An electronics module configured for contact with liquid fuel in a fuel tank, comprising:
a fluid encapsulant; and
electronics immersed in the fluid encapsulant.

2. The electronics module of claim 1 further comprising a sealed housing carrying the electronics therein.

3. The electronics module of claim 2 wherein the sealed housing includes a first housing component, and a second housing component mechanically sealed to the first housing component.

4. The electronics module of claim 3 wherein the second housing component is mechanically sealed to the first housing component using a polymeric, fluid-tight mechanical seal disposed between the first and second housing components.

5. The electronics module of claim 1 wherein the electronics include a circuit board carrying a plurality of electronic devices.

6. The electronics module of claim 5 wherein the plurality of electronic devices include at least one microprocessor.

7. The electronics module of claim 5 wherein the electronics include controller electronics for a fuel pump assembly.

8. The electronics module of claim 1 wherein the fluid encapsulant is a liquid encapsulant and wherein the liquid fuel will become suspended in and diluted by the liquid encapsulant if the liquid fuel enters the electronics module.

9. The electronics module of claim 8 wherein the liquid encapsulant is based on at least one of organic or inorganic fluids.

10. The electronics module of claim 9 wherein the liquid encapsulant is at least one of a transformer oil, a silicone fluid, or a fluourinert fluid.

11. The electronics module of claim 1 wherein the encapsulant is based on at least one of an organic or inorganic gel or grease.

12. The electronics module of claim 1 wherein the fluid encapsulant is a liquid encapsulant and includes an additive to neutralize corrosive compounds present in the liquid fuel.

13. An electronics module of a fuel pump assembly, configured for contact with liquid fuel in a fuel tank, comprising:
a sealed housing;
a liquid encapsulant carried within the sealed housing; and
electronics carried within the housing and immersed in the liquid encapsulant.

14. The sealed electronics module of claim 13 wherein the sealed housing is composed of a polymeric material.

15. The electronics module of claim 13 wherein the sealed housing includes a first housing component, and a second housing component mechanically sealed to the first housing component.

16. The electronics module of claim 15 wherein the second housing component is mechanically sealed to the first housing component using a polymeric, fluid-tight mechanical seal disposed between the first and second housing components.

17. The electronics module of claim 13 wherein the electronics include a circuit board carrying a plurality of electronic devices.

18. The electronics module of claim 17 wherein the plurality of electronic devices include at least one microprocessor.

19. The electronics module of claim 17 wherein the electronics are controller electronics for a fuel pump assembly.

20. The electronics module of claim 13 wherein the liquid encapsulant is based on at least one of organic or inorganic fluids.

21. The electronics module of claim 20 wherein the liquid encapsulant is at least one of a transformer oil, a silicone fluid, or a fluourinert fluid.

22. The electronics module of claim 13 wherein the encapsulant is based on at least one of an organic or inorganic gel or grease.

23. The electronics module of claim 13 wherein the liquid encapsulant includes an additive to neutralize corrosive compounds present in fuel.

24. A fuel pump assembly for use in a vehicle fuel tank, comprising:
a fuel pump motor; and
an electronics module in communication with the fuel pump motor and being configured for contact with liquid fuel in the vehicle fuel tank including:
a sealed housing;
a liquid encapsulant carried within the sealed housing; and
electronics carried within the housing and immersed in the liquid encapsulant.
